(19) United States
(12) Patent Application Publication
(10) Pub. No.: US 2007/0171214 A1
(43) Pub. Date: Jul. 26, 2007

(54) DRIVER IC FOR TRANSFORMING IMAGE DATA ARRANGED IN A STRIPE FORMAT INTO IMAGE DATA ARRANGED IN A DELTA FORMAT AND DISPLAY USING THE SAME

(76) Inventor: Chien-Chih Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/419,752

(22) Filed: May 22, 2006

(30) Foreign Application Priority Data
Jan. 20, 2006 (TW) 095102366

(51) Int. Cl. G09G 5/00

(52) U.S. Cl. 345/204

(57) ABSTRACT

A driver integrated circuit with a central processing unit interface and a display panel in a delta arrangement are incorporated in a display. The central processing unit interface of the driver IC receives an image data arranged in a stripe format. An image transformation device of the driver IC transforms the image data arranged in the stripe format into an image data arranged in a delta format, and stores the image data arranged in the delta format in memory of the driver IC. Finally, a digital-to-analog converter transforms the image data arranged in the delta format into analog image data and outputs the analog image data to a display panel in the delta arrangement. Storing image data arranged in the delta format instead of the image data arranged in the stripe format significantly reduces required memory space.

### BACKGROUND OF THE INVENTION

1. Field of the Invention

The present invention relates to a driver integrated circuit and a display thereof, and more particularly, to a display capable of transforming image data arranged in a stripe format into image data arranged in a delta format.

2. Description of the Prior Art

A central processing unit interface (CPU I/F) is usually incorporated in a cell phone. Since it is not necessary to update data shown on a display panel of the cell phone frequently, a system of the cell phone transmits image data to a driver integrated circuit (IC) only when updating data displayed on the display panel. Such a driver IC includes a memory to store the image data from the system, and thereby the driver IC with the CPU I/F can read the image data continuously and display image on the liquid crystal display (LCD) panel.

Another common interface is an RGB interface (RGB I/F), mainly incorporated in electronic devices, such as digital cameras (DCs), digital videos (DVs), and personal digital assistants (PDAs). Since these electronic devices need to update images frequently (with updating speeds of up to fifty times per second or more), the system must transmit image data to the driver IC continuously, even though the image on the display panel is the same. Therefore, the driver IC with RGB I/F does not include a memory.

Referring to FIG. 1, which is a diagram of a driver IC 1 with a CPU I/F 10 according to the prior art. The driver IC 1 comprises the CPU I/F 10, a memory 20, a digital-to-analog converter 18, a timing generator 16, a memory controller 14, and a command decoder 12. The CPU I/F 10 receives image data and another controlling signals from the system. The image data is stored in the memory 20. The digital-to-analog converter 18 accesses image data from the memory 20, transforms it into analog image data, and finally outputs it to an LCD panel. The command decoder 12 decodes the another controlling signals so as to control the operation of the driver IC 1. The timing generator 16 generates clocks required by the driver IC 1. The memory controller 14 controls access of the memory 20.

Most LCD panels incorporated in cell phones are RGB panels in a stripe arrangement. Referring to FIG. 2, which is an RGB panel 2 in the stripe arrangement, where R, G, and B sub-pixels in different rows are aligned, respectively.

Take the driver IC 1 of FIG. 1 and the RGB panel 2 of FIG. 2 in the stripe arrangement for example. Until recently, panel resolution was typically 128*3*128, using 4 bits of data for each R, G. and B sub-pixel. Therefore, the memory 20 needed memory space of 128*3*128*4 bits (about 192 KBits). However, these days, cell phones have advanced functions, such as digital cameras with million-pixel resolution and video playback capability, which require high image quality. Most display panels used in cell phones use QVGA resolution, 320*3*240, using 6 bits of data for each R, G, and B sub-pixel. The capacity of the memory 20 must be increased to 320*3*240*6 bits (about 1380 KBits), an increase of seven times. Therefore, it becomes important to reduce the memory space of the CPU I/F driver IC without decreasing image quality.

### SUMMARY OF THE INVENTION

The present invention provides a display for transforming an image data arranged in a stripe format into an image data arranged in a delta format. The display comprises a display panel, a plurality of pixel units, a plurality of signal lines, and at least one driver integrated circuit (IC) electrically connected to the signal lines. The display panel comprises a base including an active area and at least one peripheral area adjacent to the active area. The pixel units are formed on the active area of the base in a delta arrangement. The signal lines are formed on the active area and the peripheral area and electrically connected to the pixel units. The driver IC comprises at least one central processing unit interface (CPU I/F), at least one first image transformation device, at least one memory, and at least one digital-to-analog converter. The central processing unit interface receives image data arranged in the stripe format; the first image transformation device is electrically coupled to the CPU I/F for transforming the image data arranged in the stripe format from the CPU I/F into an image data arranged in the delta format; the memory is electrically coupled to the first image transformation device for storing the image data arranged in the delta format from the first image transformation device; and the digital-to-analog converter is electrically coupled to the memory for converting the image data arranged in the delta format into analog image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a driver IC with a CPU I/F according to the prior art.

FIG. 2 is a diagram of an RGB display panel in a stripe arrangement.

FIG. 3 is a diagram of a driver IC with a CPU I/F according to the present invention.

FIG. 4 is a diagram of an RGB display panel in a delta arrangement.

FIG. 5 and FIG. 6 show other embodiments of the present invention.

FIG. 7 shows the driver IC of FIG. 3 positioned on the display panel of FIG. 4.

FIG. 8 shows the driver IC of FIG. 3 positioned on at a circuit board.

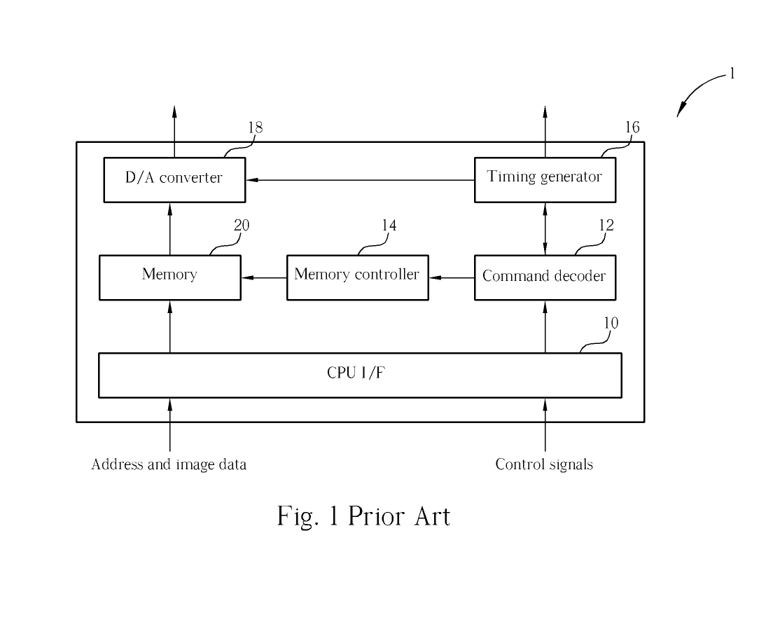

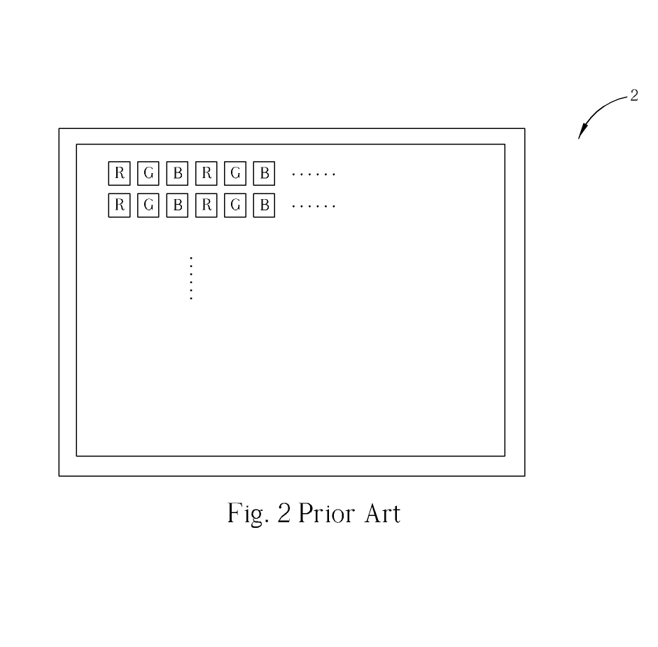

### DETAILED DESCRIPTION

The RGB display panel in the stripe arrangement of a cell phone of the prior art uses QVGA resolution of 320*3*240, using 6 bits of data for each R, G, and B sub-pixel, and thereby requires memory space of 320*3*240*6 bits (about 1380 KBits). However, the present invention utilizes a delta RGB display panel with 640*240 resolution, and uses the QVGA image format. Storing image data arranged in the delta format instead of image data arranged in the stripe format significantly reduces memory space.

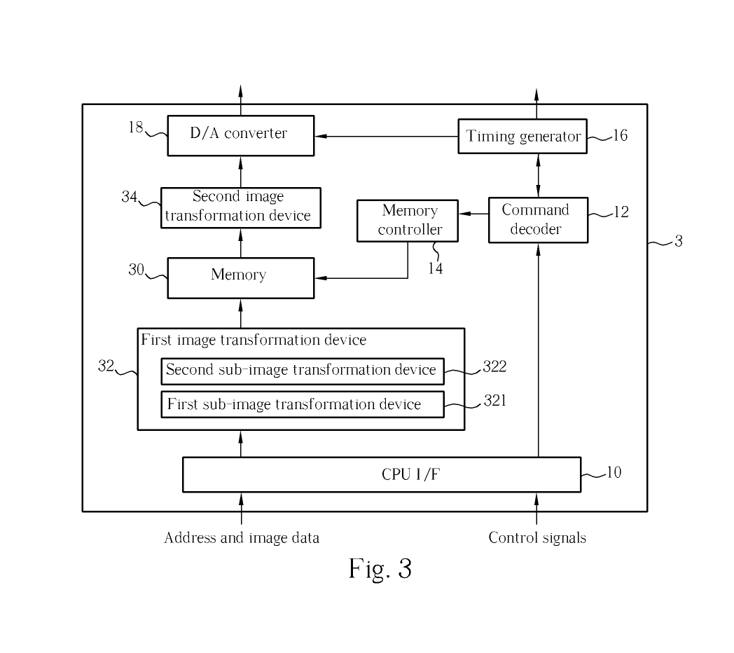

Referring to FIG. 3, which is a diagram of a driver IC 3 with the CPU I/F 10 according to the present invention. The driver IC 3 comprises at least one CPU I/F 10, at least one memory 30, at least one digital-to-analog converter 18, at least one timing generator 16, at least one memory controller 14, at least one command decoder 12, at least one first image transformation device 32, and at least one second image transformation device 34, wherein the first image transformation device 32 comprises at least one first sub-image transformation device 321 and at least one second sub-image transformation device 322.

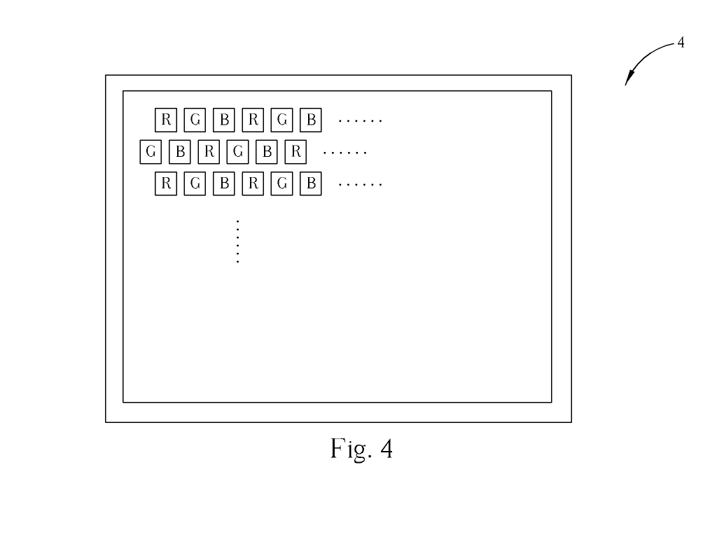

FIG. 4 is an RGB delta display panel 4 with 640*240 resolution. Such a display panel 4 is commonly used in digital cameras and digital videos. According to the delta arrangement, for example, suppose the sequence of sub-pixels in the upper row is RGBRGB . . . , and the next row is GBRGBR . . . , where the second sub-pixel of the next row, B, is positioned between the first sub-pixel, R, and the second sub-pixel, G, of the upper row. In other words, sub-pixels between two rows are in a regular triangle arrangement or an inverted triangle arrangement. The delta display panel 4 has the advantage that the panel resolution is low while the image quality is still good. When displaying elaborate characters, some nonlinear edges might occur. However, such nonlinear edges can be tolerated as long as users can still read these characters.

Take the driver IC 3 of FIG. 3 and the RGB delta display panel 4 for example to shed light on the present invention. The CPU I/F 10 receives the image data and controlling signals from the system. The image data is an image data arranged in the stripe format of RGB format. The first sub-image transformation device 321 of the first image transformation device 32 transforms the image data arranged in the stripe format of RGB format into an image data arranged in the delta format of RGB format, resulting in image reduction from 320*3*240*6 bits (about 1380 KBits) to 640*240*6 bits (about 922 KBits) and saving 33% of the space of the memory 30. Next, the second sub-image transformation device 322 of the first image transformation device 32 transforms the image data arranged in the delta format of RGB format into an image data arranged in the delta format of YUV format, and thereby reduces image data to 640/6*240*(6*2+6+6) bits (about 622 KBits). Then the image data arranged in the delta format of YUV format is stored in the memory 30. With image transformation, the present invention can reduce the space of the memory 30 of the driver IC 3. Since the display panel that the present invention uses is the RGB delta display panel 4, the second image transformation device 34 reads the image data arranged in the delta format of YUV format from the memory 30, transforms it into the image data arranged in the delta format of RGB format, and finally outputs it to the digital-to-analog converter 18 to transform it into analog image data displayed on the RGB delta display panel 4. In this embodiment, the present invention transforms image data arranged in the stripe format into image data arranged in the delta format, and then transforms RGB format into YUV format so as to reduce by about 50% the space required in the memory 30.

Another embodiment related to the above is the first sub-image transformation device 321 of the first image transformation device 32 transforming the image data arranged in the stripe format of RGB format into an image data arranged in the stripe format of YUV format, reducing image data from 320*3*240*6 bits (about 1380 KBits) to 320*3/6*240*(6*2+6+6) bits (about 920 KBits) and saving 33% of the space of the memory 30. Next, the second sub-image transformation device 322 of the first image transformation device 32 transforms the image data arranged in the stripe format of YUV format into an image data arranged in the delta format of YUV format, reducing image data to 640/6*240*(6*2+6+6) bits (about 622 KBits), and stores the image data arranged in the delta format of YUV format in the memory 30. The second image transformation device 34 accesses the image data arranged in the delta format of YUV format, transforms into the image data arranged in the delta format of RGB format, and outputs to the digital-to-analog converter 18 to transform into analog image data displayed on the RGB display panel 4 in the delta arrangement. In this embodiment, the present invention transforms RGB format into YUV format, and then transforms the image data arranged in the stripe format into the image data arranged in the delta format for image memory reduction of about 50%.

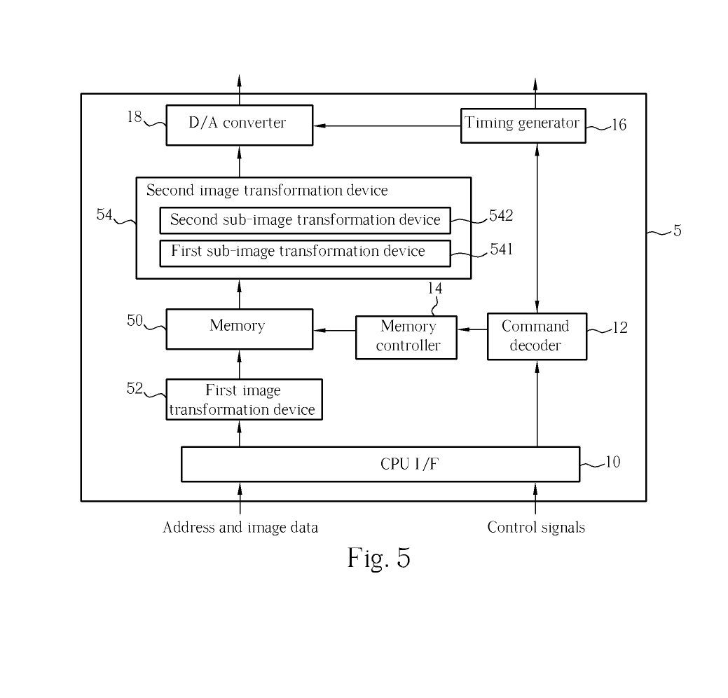

Referring to FIG. 5, which is an embodiment of a driver IC 5 with the CPU I/F 10 according to the present invention. The driver IC 5 comprises at least one CPU I/F 10, at least one memory 50, at least one digital-to-analog converter 18, at least one timing generator 16, at least one memory controller 14, at least one command decoder 12, at least one first image transformation device 52, and at least one second image transformation device 54. The second image transformation device 54 comprises at least one first sub-image transformation device 541 and at least one second sub-image transformation device 542.

Take the driver IC 5 of FIG. 5 and the RGB delta display panel 4 for example. The CPU I/F 10 receives the image data and controlling signals from the system. The image data is an image data arranged in the stripe format of RGB format. The first image transformation device 52 transforms the image data arranged in the stripe format of RGB format into an image data, arranged in the stripe format of YUV format resulting in image reduction from 320*3*240*6 bits (about 1380 KBits) to 320*3/6*240*(6*2+6+6) bits (about 920 KBits). The image data arranged in the stripe format of YUV format is stored in the memory 50. Next, the first sub-image transformation device 541 of the second image transformation device 54 transforms the image data arranged in the stripe format of YUV format into the image data arranged in the stripe format of RGB format. Then, the second sub-image transformation device 542 of the second image transformation device 54 transforms the image data arranged in the stripe format of RGB format into an image data arranged in the delta format of RGB format, and finally outputs it to the digital-to-analog converter 18 to transform it into analog image data displayed on the RGB display panel 4 in the delta arrangement. In this embodiment, the present invention transforms image data of RGB format into image data of YUV format so as to reduce by about 33% the required space of the memory 50.

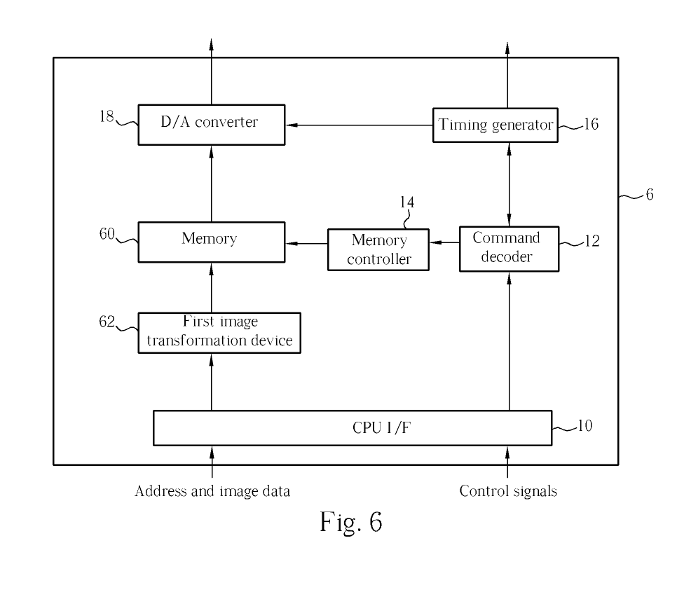

Referring to FIG. 6, which is an embodiment of a driver IC 6 with the CPU I/F 10 according to the present invention. The driver IC 6 comprises at least one CPU I/F 10, at least one memory 60, at least one digital-to-analog converter 18, at least one timing generator 16, at least one memory controller 14, at least one command decoder 12, and at least one first image transformation device 62.

Take the driver IC 6 of FIG. 6 and the RGB delta display panel 4 for example. The first image transformation device 62 transforms the image data arranged in the stripe format of RGB format into an image data arranged in the delta format of RGB format. Then the image data arranged in the delta format of RGB format is stored in the memory 60, and no YUV format transformation is executed. The image data is reduced from 320*3*240*6 bits (about 1380 KBits) to 640*240*6 bits (about 922 KBits), a reduction of about 33%. Next, the digital-to-analog converter 18 reads the image data arranged in the delta format of RGB format from the memory 60 and transforms it into analog image data. In this embodiment, the present invention only transforms the image data arranged in the stripe format into the image data arranged in the delta format so as to reduce by about 33% the required space of the memory 60.

In addition, according to the controlling signals from the system, the driver ICs 3, 5, 6 of the present invention can perform different image compression on different image regions, or compress some image regions and not compress some image regions so as to conform to different image requirements. For instance, picture compression is performed on picture regions, and character regions are not compressed, but the gray levels of these character regions are reduced.

The present invention integrates the delta display panel 4 with lower resolution and the driver ICs 3, 5, 6 to transform image data before being stored in the memories 30, 50, 60 so that image reduction can be achieved. Additionally, the delta display panel 4 can be a three-color display panel, such as RGB or YMC, or a four-color display panel, such as RGBW or RGBC. White can be mixed by three fundamental colors and other colors, such as RGBY or RGC. Thus, the image transformation is different based on the used display panel.

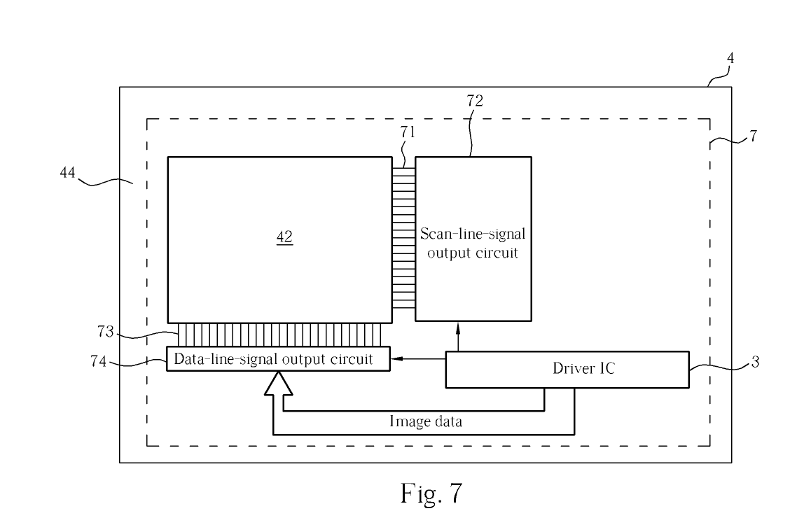

The driver ICs 3, 5, 6 can be positioned on the display panel 4 or on a circuit board. Referring to FIG. 7, which shows the driver IC 3 of FIG. 3 positioned on the display panel 4 of FIG. 4. The display panel 4 comprises a base 7 having an active area 42 and at least one peripheral area 44 adjacent to the active area 42. Sub-pixels of FIG. 4 are positioned on the active area 42 of the base 4 in a delta arrangement. A scan-line-signal output circuit 72, a data-line-signal output circuit 74 and the driver IC 3 are usually placed on the base 7 via a chip-on-glass (COG) process. A plurality of scanning lines 71 is positioned on the active area 42 and the peripheral area 44, and electrically connected to the scan-line-signal output circuit 72 and to pixel units of FIG. 4. A plurality of data lines 7 is positioned on the active area 42 and the peripheral area 44, and electrically connected to the data-line-signal output circuit 74 and to pixel units of FIG. 4. The scan-line-signal output circuit 72 and the data-line-signal output circuit 74 display images on the active area 42 according to controlling signals of the driver IC 3 and the image data.

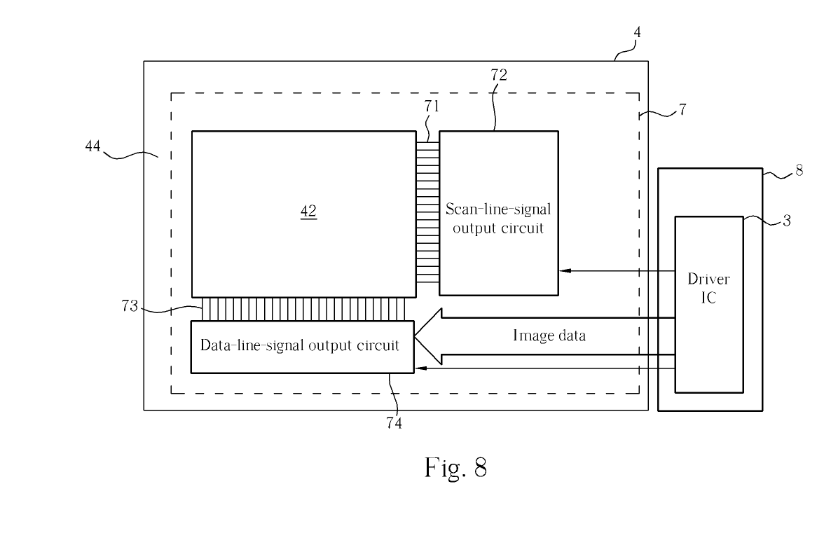

FIG. 8 shows the driver IC 3 of FIG. 3 positioned on at least one circuit board 8. The difference between FIG. 8 and FIG. 7 is the position of the driver IC 3. The driver IC 3 is positioned on the circuit board 8. The circuit board 8 is positioned at one side of the peripheral area 44, far from the active area 42, and electrically connected to the scan-line-signal output circuit 72 and the data-line-signal output circuit 74. The other elements are the same as those of FIG. 7. The circuit board 8 of FIG. 8 can be a printed circuit board or a flexible printed circuit board. The display panel 4 can be a liquid crystal display (LCD) panel or an organic electroluminescent display (OELD) panel made via an α-Si process or a low temperature poly-silicon (LTPS) process. The OELD panel comprises organic light emitting diodes (OLED) or polymer light emitting diodes (PLED).

The present invention provides a display with CPU I/F to transform the image data arranged in the stripe format into the image data arranged in the delta format. Able to produce high quality video, the present invention integrates the CPU I/F driver IC and the delta display panel to store the image data arranged in the delta format or compressed image data so as to reduce required memory space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display comprising:
a display panel comprising a base including an active area and at least one peripheral area adjacent to the active area;
a plurality of pixel units formed on the active area of the base in a delta arrangement;
a plurality of signal lines formed on the active area and the peripheral area and electrically connected to the pixel units; and
at least one driver integrated circuit (IC) electrically connected to the signal lines, the driver IC comprising:
at least one central processing unit interface (CPU I/F) for receiving an image data arranged in a stripe format;
at least one first image transformation device, electrically coupled to the CPU I/F, for transforming the image data arranged in the stripe format from the CPU I/F into an image data arranged in a delta format;
at least one memory, electrically coupled to the first image transformation device, for storing the image data arranged in the delta format from the first image transformation device; and
at least one digital-to-analog converter, electrically coupled to the memory, for converting the image data arranged in the delta format into analog image data.

2. The display of claim 1, wherein the first image transformation device comprises a first sub-image transformation device for transforming the image data arranged in the stripe format of a first format from the CPU I/F into the image data arranged in the delta format of the first format, and a second sub-image transformation device for transforming the image data arranged in the delta format of the first format into image data arranged in the delta format of a second format.

3. The display of claim 2, wherein the driver IC further comprises at least one second image transformation device, electrically coupled between the memory and the digital-to-analog converter, for transforming the image data arranged in the delta format of the second format stored in the memory into the image data arranged in the delta format of the first format.

4. The display of claim 1, wherein the first image transformation device comprises a first sub-image transformation device for transforming the image data arranged in the stripe format of a first format from the CPU I/F into image data arranged in the stripe format of a second format, and a second sub-image transformation device for transforming the image data arranged in the stripe format of the second format into the image data arranged in the delta format of the second format.

5. The display of claim 4, wherein the driver IC further comprises at least one second image transformation device, electrically coupled between the memory and the digital-to-analog converter, for transforming the image data arranged in the delta format of the second format stored in the memory into the image data arranged in the delta format of the first format.

6. The display of claim 1, wherein the driver IC is positioned in the peripheral area.

7. The display of claim 1 further comprising a circuit board positioned at a side of the peripheral area and far away from the active area, the driver IC being positioned on the circuit board.

8. A display comprising:
a display panel comprising a base including an active area and at least one peripheral area adjacent to the active area;
a plurality of pixel units formed on the active area of the base in a delta arrangement;
a plurality of signal lines formed on the active area and the peripheral area and electrically connected to the pixel units; and
at least one driver integrated circuit (IC) electrically connected to the signal lines, the driver IC comprising:
at least one central processing unit interface (CPU I/F) for receiving an image data arranged in a stripe format;
at least one first image transformation device, electrically coupled to the CPU I/F, for transforming the image data arranged in the stripe format of a first format from the CPU I/F into the image data arranged in the stripe format of a second format;
at least one memory, electrically coupled to the first image transformation device, for storing the image data arranged in the stripe format of the second format from the first image transformation device;
at least one second image transformation device, electrically coupled to the memory, for transforming the image data arranged in the stripe format of the second format into an image data arranged in a delta format of the first format; and
at least one digital-to-analog converter, electrically coupled to the second image transformation device, for converting the image data arranged in the delta format into analog image data.

9. The display of claim 8, wherein the second image transformation device comprises a first sub-image transformation device for transforming the image data arranged in the stripe format of the second format into the image data arranged in the stripe format of the first format, and a second sub-image transformation device for transforming the image data arranged in the stripe format of the first format into the image data arranged in the delta format of the first format.

10. The display of claim 8, wherein the driver IC is positioned in the peripheral area.

11. The display of claim 8 further comprising a circuit board positioned at a side of the peripheral area and far away from the active area, the driver IC being positioned on the circuit board.

12. A driver integrated circuit (IC) comprising:
at least one central processing unit interface (CPU I/F) for receiving an image data arranged in a stripe format;
at least one first image transformation device, electrically coupled to the CPU I/F, for transforming the image data arranged in the stripe format from the CPU I/F into an image data arranged in a delta format;
at least one memory, electrically coupled to the first image transformation device, for storing the image data arranged in the delta format from the first image transformation device; and
at least one digital-to-analog converter, electrically coupled to the memory, for converting the image data arranged in the delta format into analog image data.

13. The driver IC of claim 12, wherein the first image transformation device comprises a first sub-image transformation device for transforming the image data arranged in the stripe format of a first format from the CPU I/F into the image data arranged in the delta format of the first format, and a second sub-image transformation device for transforming the image data arranged in the delta format of the first format into the image data arranged in the delta format of a second format.

14. The driver IC of claim 13 further comprising at least one second image transformation device, electrically coupled between the memory and the digital-to-analog converter, for transforming the image data arranged in the delta format of the second format stored in the memory into the image data arranged in the delta format of the first format.

15. The driver IC of claim 12, wherein the first image transformation device comprises a first sub-image transformation device for transforming the image data arranged in the stripe format of a first format from the CPU I/F into the image data arranged in the stripe format of a second format, and a second sub-image transformation device for transforming the image data arranged in the stripe format of the second format into the image data arranged in the delta format of the second format.

16. The driver IC of claim 15 further comprising at least one second image transformation device, electrically coupled between the memory and the digital-to-analog converter, for transforming the image data arranged in the delta format of the second format stored in the memory into the image data arranged in the delta format of the first format.

17. A driver integrated circuit (IC) comprising:
at least one central processing unit interface (CPU I/F) for receiving an image data arranged in a stripe format;
at least one first image transformation device, electrically coupled to the CPU I/F, for transforming the image data arranged in the stripe format of a first format from the CPU I/F into the image data arranged in the stripe format of a second format;
at least one memory, electrically coupled to the first image transformation device, for storing the image data arranged in the stripe format of the second format from the first image transformation device;
at least one second image transformation device, electrically coupled to the memory, for transforming the image data arranged in the stripe format of the second format into an image data arranged in a delta format of the first format;
at least one digital-to-analog converter, electrically coupled to the second image transformation device, for converting the image data arranged in the delta format of the first format into analog image data.

18. The driver IC of claim 17, wherein the second image transformation device comprises a first sub-image transformation device for transforming the image data arranged in the stripe format of the second format into the image data arranged in the stripe format of the first format, and a second sub-image transformation device for transforming the image data arranged in the stripe format of the first format into the image data arranged in the delta format of the first format.
